(19) United States
(12) Patent Application Publication
(10) Pub. No.: US 2022/0146426 A1
(43) Pub. Date: May 12, 2022

(54) TEST APPARATUS

(71) Applicant: UNIVERSITY OF EXETER, Exeter, Devon (GB)

(72) Inventors: Robert BEARDMORE, Exeter, Devon (GB); Ivana BEARDMORE, Exeter, Devon (GB); Kai LONGSHAW, Exeter, Devon (GB); Carlos REDING, Exeter, Devon (GB)

(73) Assignee: UNIVERSITY OF EXETER, Exeter, Devon (GB)

(21) Appl. No.: 17/430,565

(22) PCT Filed: Feb. 12, 2020
(86) PCT No.: PCT/GB2020/050321

§ 371 Date: Aug. 12, 2021

(30) Foreign Application Priority Data
Feb. 14, 2019 (GB) 1902022.1

(51) Int. Cl. G01N 21/64

(52) U.S. Cl. CPC G01N 21/6454; G01N 21/6428; G01N 21/6486

(57) ABSTRACT

A test apparatus is disclosed that has a housing containing a location at which a sample tray containing a plurality of sample wells can be located, a light box positioned to permit irradiation of the sample tray, and an imaging arrangement to permit imaging of the sample tray. The light box has a light source including a light guide in the form of a plate of a transparent material and a plurality of light emitting devices provided adjacent at least one edge of the plate where a surface of the plate is provided with a plurality of transmitting regions and light is transmitted from the plate.

This invention relates to a test apparatus for use in conducting tests on samples, and in particular biological samples. In particular, it relates to a test apparatus designed in such a manner as to allow tests to be conducted upon a plurality of samples substantially simultaneously. The invention also relates to associated methods for calibrating and using the test apparatus.

There are a number of applications in which it is desired to illuminate or irradiate a sample, and in particular a biological sample, with light of a selected wavelength or wavelength profile. The irradiation of the sample in this manner may result in excitation of the sample and fluorescence thereof at a different wavelength. By monitoring the sample excited in this fashion to determine whether or not such fluorescence occurs, and by monitoring the level of such fluorescence, characteristics of the sample can be ascertained.

A number of test apparatus designs capable of performing this function are known.

A typical test apparatus design of this type comprises a housing within which a sample tray containing a number of sample wells is located. A light source is mounted upon an adjustable mechanism to allow the light source to be positioned adjacent each sample well, in turn. The light source is used to irradiate and excite the sample, and a monitoring arrangement is used to monitor for fluorescence of the sample. By irradiating the sample wells in turn using the same light source, it will be appreciated that each sample well will be irradiated with light of substantially the same intensity and wavelength.

As the light source has to be moved to a position adjacent each sample well, in turn, it will be appreciated that the device is of relatively complex form, having a number of moving parts, and that conducting tests on a number of samples is a time consuming, complex operation, taking, for example, several minutes to undertake. Depending upon the nature of the test being undertaken, potentially some of the samples may have deteriorated before irradiation thereof may be undertaken. The quality of the results achievable using such an apparatus may thus be limited in some circumstances.

Alternative designs are known in which the light source is fixed, and a complex optical arrangement is provided to result in irradiation of the sample wells in turn. Whilst such an arrangement has a fixed light source, the nature of the optical arrangement results in such a design suffering from substantially the same problems as the design outlined above.

Furthermore, difficulties can be faced in ensuring that all sample wells receive the same level of irradiation, negatively impacting upon the test results. It is common for users to feel that the “outer” wells of a sample tray produce different results from the “inner” wells of a sample tray when tested using such an apparatus.

It is an object of the invention to provide a test apparatus in which at least some of the disadvantages associated with known test apparatus designs are overcome or are of reduced impact.

According to the present invention there is provided a test apparatus comprising a housing containing a location at which a sample tray containing a plurality of sample wells can be located, a light box positioned or positionable to permit irradiation of substantially the entirety of the sample tray, and an imaging arrangement to permit imaging of substantially the entirety of the sample tray, wherein the light box comprises light source including a light guide in the form of a plate and a plurality of light emitting devices provided adjacent at least one edge of the plate, wherein a surface of the plate is provided with a plurality of transmitting regions whereby light is transmitted from the plate.

The light box conveniently comprises a lid of the housing, preferably hingedly or pivotally connected to the remainder of the housing.

The number of transmitting regions is preferably greater than or equal to the number of sample wells. The transmitting regions are preferably formed by etching of the surface of the plate. The transmitting regions are conveniently of circular shape. However, other shapes such as ellipses are also possible. The transmitting regions are preferably arranged in a regular pattern or array over the plate. They may be of different shapes and/or sizes to one another, if desired.

It will be appreciated that the use of a light box of this type is advantageous in that all of the sample wells can be illuminated simultaneously, allowing tests to be undertaken upon all of the samples substantially simultaneously. The need to provide mechanisms to move the light source or associated optical devices to positions adjacent each sample well, in turn, is avoided. The light box, and the test apparatus as a whole, may thus be of relatively simple and low cost form compared to traditional designs, whilst having significant benefits compared to a traditional test apparatus design. Use of the test apparatus to conduct tests upon a number of samples is also simplified.

The light emitting devices preferably take the form of light emitting diodes. Conveniently, light emitting diodes having different wavelength outputs are used so that, by appropriate control over the operation of the light emitting diodes, the colour of the light used to excite the samples can be controlled. By way of example, light emitting diodes having red (621 nm), green (525 nm) and blue (465 nm) outputs may be used. Depending upon how the apparatus is controlled, using all three colours in combination may result in irradiation of the samples with a bluish white light which has been found to work well when for reading E Coli densities, but the colours can be used individually, if desired, to allow, for example, irradiation with a red light, or may be used in other combinations to produce other colours. The colour selection may depend upon the nature of the test being undertaken.

The imaging arrangement preferably comprises a projection plate located below and adjacent the sample tray, to the opposite side of the sample tray to the light box, and an imaging device operable to capture an image or images of the projection plate. If desired, a filter device may be located between the projection plate and the imaging device such that the captured image may include or exclude certain wavelengths. By way of example, it may be desired to filter out the excitation light wavelengths so that fluorescence of the samples is more easily seen. A motorised drive arrangement may be provided to drive the filter device for movement to control the wavelengths filtered thereby.

Whilst the light box described hereinbefore is advantageous in that it applies a substantially uniform level of irradiation to all of the sample wells simultaneously, there may still be some variance in the actual level of irradiation of the various sample wells. In order to address this, it is another object of the invention to provide a calibration method and a corresponding method of use of the test apparatus.

The invention also relates to a light box adapted for use in the above described test apparatus.

According to a second aspect of the invention there is provided a method of calibrating a test apparatus of the type set out hereinbefore, the calibration method comprising the steps of operating the light source at a first output intensity, with no samples present in the test apparatus or with all wells of the sample tray containing the same sample medium, using the imaging arrangement to image the projection plate to obtain an image intensity value for each sample well location associated therewith, repeating the operating and imaging operations with the light source operating at different output intensities, and using the image intensity values so derived to identify, for each sample well location, a test output intensity for which the image intensity value matches a desired image intensity value common to all well locations.

According to a third aspect of the invention there is provided a method of conducting a test using the test apparatus set out hereinbefore and the result of the calibration method set out hereinbefore, the method comprising the steps of locating a sample tray containing a number of samples within the test apparatus, operating the light source of the light box at a series of different output intensities to irradiate the samples, using the imaging arrangement to capture images of the projection plate for each output intensity, and using, for each sample location, the image captured when the output intensity matches the respective test output intensity in conducting further steps of the test.

It will be appreciated that by conducting the test in this manner it can be ensured that the captured images used in the remainder of the test are calibrated and relate to the result of irradiation of all of the samples with light of a uniform intensity. Consequently, tests can be undertaken with an enhanced level of accuracy.

The invention will further be described, by way of example, with reference to the accompanying drawings, in which:

FIG. 1 is a perspective view of a test apparatus in accordance with an embodiment of the invention in an open condition;

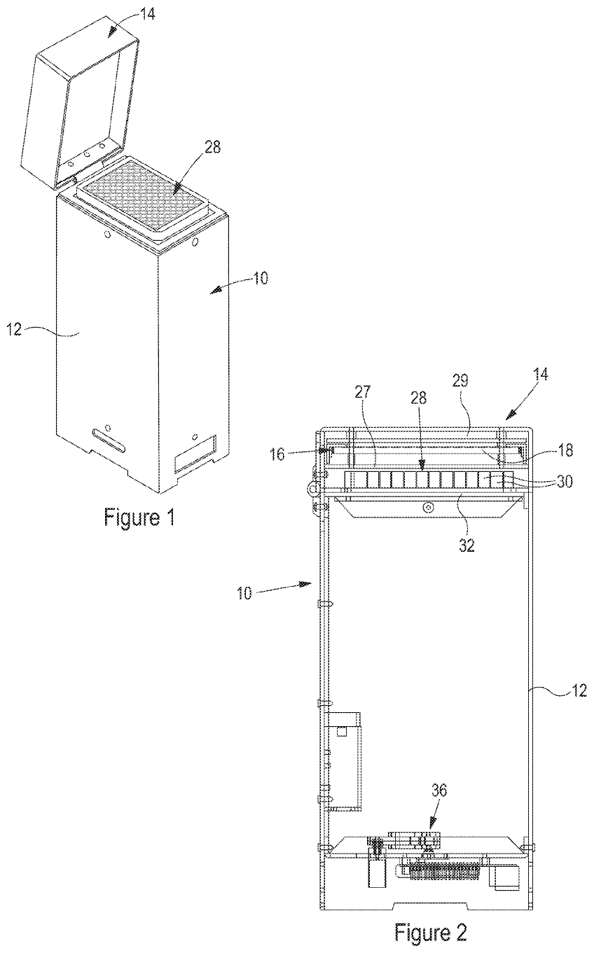

FIG. 2 is a sectional view illustrating the test apparatus;

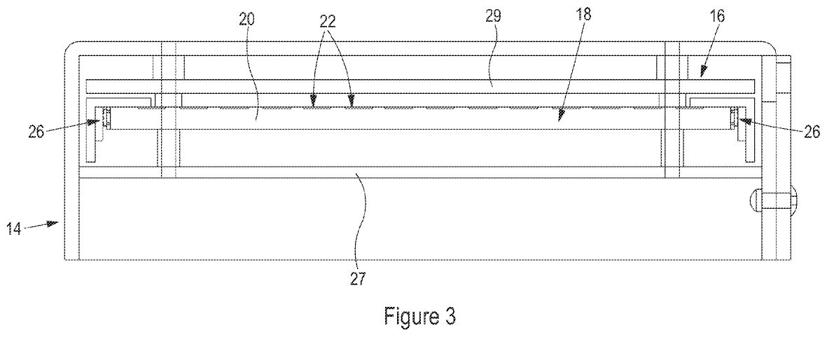

FIG. 3 is a sectional view illustrating the light box of the test apparatus;

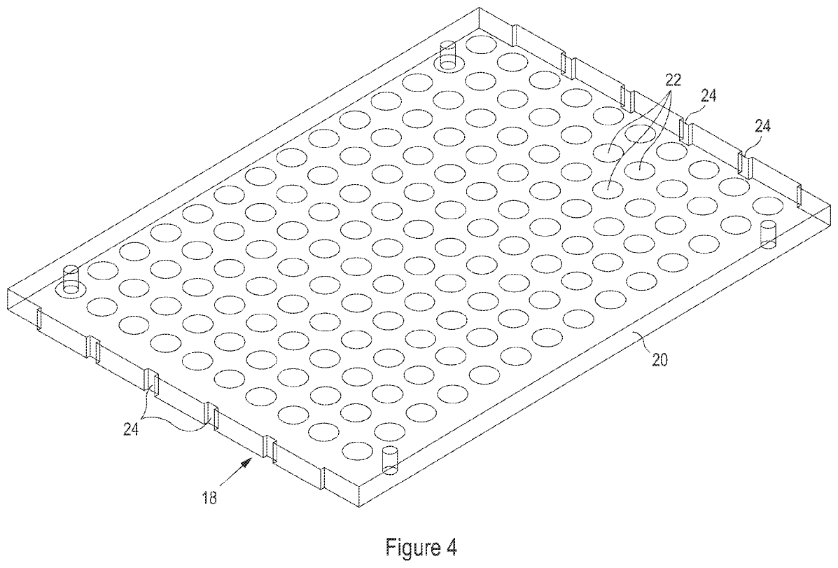

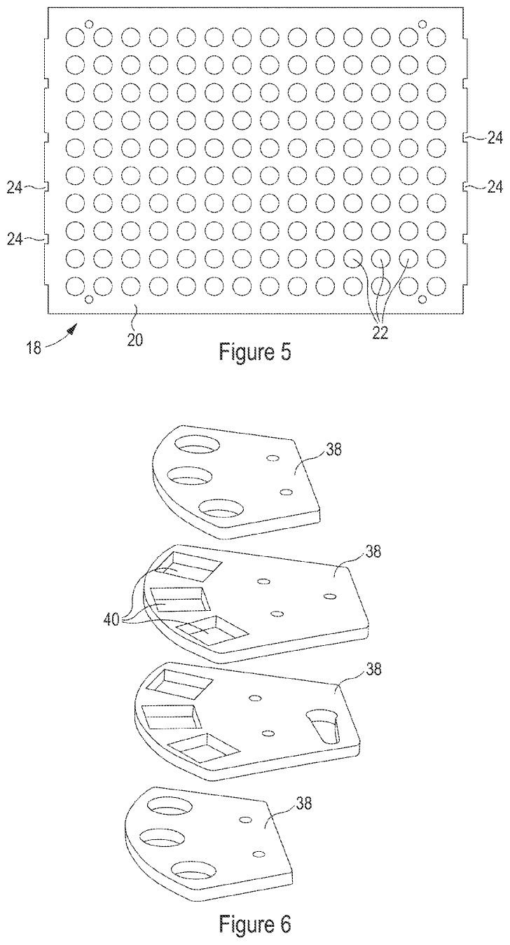

FIGS. 4 and 5 are views illustrating a light guide part of the light box;

FIG. 6 is a view illustrating another part of the test apparatus; and

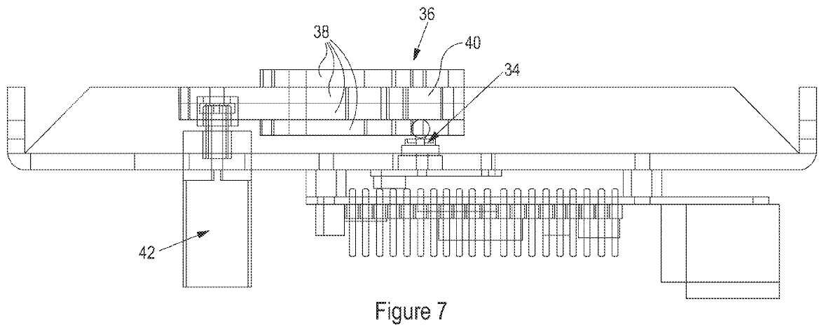

FIG. 7 is a sectional view illustrating a lower section of the test apparatus.

Referring to the accompanying drawings a test apparatus 10 is illustrated comprising a housing 12 and a lid pivotally or hingedly connected to the housing 12. The lid and housing 12, when the lid occupies a closed position, define a closed, substantially light free container.

The lid forms the housing of a light box 14, and mounted within the lid and forming part of the light box 14 is a light source 16 comprising a light guide 18 in the form of a, for example, 5 mm thick plate 20 of a transparent material such as a suitable acrylic material, a surface of which has been etched, preferably by laser, to form a series of transmitting regions 22 of slightly roughened or textured form, each of which is, in this embodiment, of circular form arranged in a regular pattern over the surface of the plate 20. Two opposing edges of the plate 20 are formed with a series of recesses 24 within which light emitted devices in the form of light emitting diodes 26 are located. The location of the light emitting diodes 26 is such that when operating, light emitted therefrom passes into the plate 20 and is guided by the plate, undergoing substantially total internal reflection when incident upon the surfaces of the plate 20 other than at the transmitting regions 22. When light is incident upon the transmitting regions 22, the etching of the plate material to pattern or roughen the surface thereof results in the total internal reflection mode being interrupted and instead in at least a proportion of the light being transmitted from the light guide 18 at these locations.

Whilst the use of circular transmitting regions 22 is illustrated, it will be appreciated that other shapes may be used. Furthermore, the transmitting regions 22 need not all be of the same shape and/or size.

A mirror or reflector 29 is located above the light guide 18 within the light box 14 to reflect any upward light back in a downward direction. A diffuser plate 27 is located beneath the light guide 18 within the light box 14. The various parts of the light source 16 are conveniently bolted to the lid with spacers used to maintain desired levels of spacing between the various parts. The bolts are conveniently of a non-reflective material or have a non-reflective coating so as not to interfere with the optical properties of the light box 14. The locations of the bolts are also selected so as to minimise their effect upon the optical properties of the light box 14.

A control arrangement (not shown) is provided to allow control over the output intensities of the light emitting diodes 26. Conveniently, the light emitting diodes 26 are of three different colours. Specifically, some of the light emitting diodes are conveniently of a type emitting red (621 nm) light, others are of a type emitting green (525 nm) light, and others are of a type emitting blue (465 nm) light. By using these light emitting diodes in combination, the output of the light source 16 may be of a bluish white colour. This output colour has be found to work well when measuring, for example, E coli densities. However, the invention is not restricted in this regard and other output colours may be used, for example depending upon the nature of the test being undertaken. Accordingly, the output could be of, for example, a reddish colour or of another colour, as desired. The control arrangement preferably allows individual control over the light emitting diodes 26, for example to allow just those of the same colour to be operated, thereby allowing a wide range of tests to be conducted using the test apparatus 10.

Located within the housing 12 an accessible when the lid of the light box 14 is in its open position, is a removable sample tray 28 containing a number of sample wells 30. By way of example, the sample tray may comprise a standard 96 well tray. The location of the sample tray 28 is such that, when positioned within the test apparatus 10 and the lid is closed, the sample tray 28 is spaced from the underside of the light source 16 of the light box 14 by a small distance, for example by 5-6 mm.

The number of transmitting regions 22 on the plate 20 is conveniently significantly greater than the number of samples wells 30, so that each sample well 30 receives light from a plurality of the transmitting regions 22. In this manner, the irradiation of the sample wells 30 can be of enhanced uniformity. By way of example, where the sample tray contains 96 sample wells 30, the plate 20 may include 140 regions 22, as shown. However, this need not always be the case and arrangements in which the number of transmitting regions 22 is smaller, for example matching or being less that the number of sample wells 30 are also possible.

Located beneath the sample tray 28 is a projection plate 32 in the form of a semi-transparent sheet such as sheet acrylic. The sample tray 28 conveniently sits directly upon the projection plate 32. To minimise distortion, the projection plate 32 should ideally be as close to the bottoms of the sample wells 30 of the tray 28 as possible. To this end, the base plate of the sample tray 28 may be used as the projection plate in some embodiments.

The bottom wall of the housing 12 is formed with an opening through which part of an image capturing device 34 projects, the image capturing device 34 being operable to capture an image of the projection plate 32.

In use, with samples located within the sample wells 30 of the sample tray 28, and with the lid of the light box 14 in its closed position, the light source 16 is operated to irradiate the samples with light, causing excitation of the samples resulting in fluorescence thereof. The fluorescence forms an image upon the projection plate 32 which can be captured using the image capturing device 34, thereby allowing information to be obtained regarding the level of fluorescence arising from the excitation of each sample with light of the wavelength and intensity output by the light source 16. It will be appreciated that images associated with the irradiation of all of the samples can be captured simultaneously, thus testing of a number of samples can be undertaken quickly and efficiently. No complex drive mechanism is required within the light source, and so the test procedure does not require adjustment of such a drive mechanism, further simplifying the test procedure, as well as simplifying the device. The output of the light source is relatively uniform, and so all samples are irradiated to substantially the same level of intensity.

Whilst not shown, if desired optical fibres or other light guides may be provided to conduct light between the projection plate 32 and the image capturing device 34 to enhance the captured image clarity. However, this is not essential and may be omitted (as shown).

As shown in the drawings, a filter arrangement 36 is preferably provided between the image capturing device 34 and the projection plate 32. The filter arrangement 36 conveniently takes the form of a plate of series of support plates 38, one of which carries a series of optical filters 40, pivotally mounted to the bottom of the housing 12, and a motorised drive arrangement 42 to allow a selected filter 40 carried by the plates 38 to be positioned immediately in front of the image capturing device 34. By way of example, the filter 40 may be arranged to filter out the wavelength(s) output by the light source 16, thereby making fluorescence of the sample more clearly visible.

Although the light box 14, and test apparatus 10, described hereinbefore is advantageous in that the light output therefrom is substantially uniform, the intensity of irradiation of certain of the samples wells may still be higher or lower than that of others of the sample wells. By way of example, there may be a variance in light intensity in the region of, say, 5%. In order to further enhance the accuracy with which tests can be conducted, it is preferable to conduct a calibration method on the test apparatus 10, and to use the result of the calibration method when conducting tests in order to compensate for such light intensity variations.

By way of example, the calibration method may involve the steps of operating the light source 16 at a first output intensity to illuminate the sample tray 28 and projection plate 32, and capturing an image of the projection plate 32 using the image capturing device 34. This method is undertaken without any samples located within the wells 30 of the tray 28, or with all of the wells 30 containing the same sample medium, for example water. The output intensity of the light source 16 is adjusted to a plurality of other levels, and for each output intensity a corresponding image of the projection plate 32 is obtained. Using the various captured images, a respective test output intensity required to achieve a given image intensity for each well location can be identified.

During subsequent use of the test apparatus 10 in conducting tests, with the sample tray 28 in position and with samples located within the sample wells, the output intensity of the light source 16 can be cycled through the various output intensities. For each output intensity, a corresponding image can be captured. Using the test output intensities derived in the calibration operation, a composite image made up of parts of the various captured images can be created, the composite image being indicative of the effect of irradiating all of the samples with a uniform intensity of irradiation.

In some tests, it is desirable to be able to heat the samples. If used in conducting such tests then a heater may be provided within the apparatus, and the projection plate 32 may be designed in such a manner as to serve to dissipate the heat to aid or enhance uniform heating of the samples. By way of example, the projection plate may be provided with a series of holes or openings to allow the distribution of heated air to heat the samples, the holes or openings being positioned away from the locations of the sample wells so as to avoid interfering with the ability to use the apparatus to capture images of the sample wells.

Whilst a specific embodiment of the test apparatus and light box has been described hereinbefore, and specific methods for capturing calibration information and for conducting tests have been described, it will be appreciated that a wide range of modifications and alterations may be made to the test apparatus and the light box and associated methods without departing from the scope of the invention as defined by the appended claims.

1: A test apparatus comprising a housing containing a location at which a sample tray containing a plurality of sample wells can be located, a light box positioned or positionable to permit irradiation of substantially the entirety of the sample tray, and an imaging arrangement to permit imaging of substantially the entirety of the sample tray, wherein the light box comprises a light source including a light guide in the form of a plate of a transparent material and a plurality of light emitting devices provided adjacent at least one edge of the plate, wherein a surface of the plate is provided with a plurality of transmitting regions whereby light is transmitted from the plate.

2: An apparatus according to claim 1, wherein the number of transmitting regions is greater than the number of sample wells.

3: The apparatus according to claim 1, wherein the transmitting regions are formed by etching of the surface of the plate.

4: The apparatus according to claim 1, wherein the transmitting regions are of circular shape.

5: The apparatus according to claim 1, wherein the transmitting regions are arranged in a regular pattern or array over the plate.

6: The apparatus according to claim 1, wherein the light emitting devices take the form of light emitting diodes.

7: The apparatus according to claim 6, wherein at least some of the light emitting diodes having different primary wavelength outputs.

8: The apparatus according to claim 1, wherein the imaging arrangement comprises a projection plate located adjacent the sample tray, and an imaging device operable to capture an image or images of the projection plate.

9: The apparatus according to claim 8, wherein a filter device is located between the projection plate and the imaging device such that the captured image may include or exclude certain wavelengths.

10: The apparatus according to claim 9, further comprising a motorised drive arrangement to drive the filter device for movement to control the wavelengths filtered thereby.

11: The apparatus according to claim 1, further comprising a light box, the light box comprising a light source including a light guide in the form of a plate of a transparent material and a plurality of light emitting devices provided adjacent at least one edge of the plate, wherein a surface of the plate is provided with a plurality of transmitting regions whereby light is transmitted from the plate.

12: A method of calibrating the test apparatus as claimed in claim 1, the method comprising the steps of:
operating the light source at a first output intensity, with no samples present in the test apparatus or with all wells of the sample tray containing the same sample medium;
using the imaging arrangement to image the projection plate to obtain an image intensity value for each sample well location associated therewith;
repeating the operating and imaging operations with the light source operating at different output intensities; and
using the image intensity values so derived to identify, for each sample well location, a test output intensity for which the image intensity value matches a desired image intensity value common to all well locations.

13: A method of conducting a test, the method comprising the steps of:
providing the test apparatus according to claim 1;
locating a sample tray containing a number of samples within the test apparatus;
operating the light source of the light box at a series of different output intensities to irradiate the samples;
using the imaging arrangement to capture images of the projection plate for each output intensity; and
using, for each sample location, the image captured when the output intensity matches the respective test output intensity in conducting further steps of the test.
